(19) United States
(12) Patent Application Publication
(10) Pub. No.: US 2026/0171765 A1
(43) Pub. Date: Jun. 18, 2026

(54) SWITCHGEAR WITH INVERTED SWITCH AND FUSE

(71) Applicant: S&C Electric Company, Chicago, IL (US)

(72) Inventor: Jennifer Delgado, Chicago, IL (US)

(73) Assignee: S&C Electric Company, Chicago, IL (US)

(21) Appl. No.: 19/348,988

(22) Filed: Oct. 3, 2025

Related U.S. Application Data
(60) Provisional application No. 63/734,817, filed on Dec. 17, 2024.

(51) Int. Cl. H02B 13/075

(52) U.S. Cl. CPC H02B 13/075

(57) ABSTRACT

Dead-front air insulated switchgear that includes switches and fuses that are mounted to a top panel of the switchgear housing so as to lower the cable connection location of the switches and fuses. More specifically, when the switch and the fuse are mounted to the top panel, the switch bushing and fuse bushing well to which the cables are attached end up being located closer to a base of the switchgear.

### CROSS-REFERENCE TO RELATED APPLICATION

This application claims the benefit of priority from the U.S. Provisional Application No. 63/734,817, filed on Dec. 17, 2024, the disclosure of which is hereby expressly incorporated herein by reference for all purposes.

### BACKGROUND

### Field

This disclosure relates generally to electrical switchgear and, more particularly, to dead-front air insulated switchgear that includes switches and fuses that are mounted to a top panel of the switchgear housing so as to lower the cable connection location of the switches and fuses.

### Discussion of the Related Art

An electrical power distribution network, often referred to as an electrical grid, typically includes power generation plants each having power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to substations typically located within a community, where the voltage is stepped down to a medium voltage for distribution. The substations provide the medium voltage power to three-phase feeders including three single-phase feeder lines that carry the same current, but are 120° apart in phase. Three-phase and/or single phase lateral lines are tapped off of the feeder that provide the medium voltage to various distribution transformers, where the voltage is stepped down to a low voltage and is provided to loads, such as homes, businesses, etc.

Power distribution networks of the type referred to above include switching devices, breakers, reclosers, interrupters, etc. that control the flow of power throughout the network. Some of these components are enclosed in external housings that are mounted on, for example, a concrete pad, or mounted underground, and are generally referred to herein as switchgear. The number and type of switchgear are application specific to the particular power network.

Live-front air insulated switchgear has been employed in these types of medium voltage power distribution networks for some time. Live-front air insulated switchgear typically include switches and fuses that are coupled to electrical cables through an open connection. The cables may extend underground through an open bottom of the switchgear, which is susceptible to vegetation and animals that may interfere with the open connection and create electrical problems. More modern dead-front air insulated switchgear that employ insulated connectors coupling the switches or fuses and the cables through various elbow connectors and soft goods are becoming the standard because of the noted advantages over live-front air insulated switchgear.

When live-front air insulated switchgear reaches the end of its life, or otherwise, it is often desirable to replace the live-front air insulated switchgear with a dead-front air insulated switchgear. However, the location where the cables are connected to the switches and fuses in the known live-front air insulated switchgear is considerably lower on the switchgear than the location where the cables are connected to the switches or fuses in the known dead-front air insulated switchgear. For example, in one specific design, the live-front air insulated switchgear switch cable terminations are roughly 25.75 inches above the support pad and in another specific design the dead-front air insulated switchgear switch cable terminations are 34.25 inches above the pad. Similarly, live-front air insulated switchgear fuse terminations are 18.875 to 23.5 inches above the pad and dead-front air insulated switchgear fuse terminations are 38.75 inches above the pad.

Replacing live-front air insulated switchgear with dead-front air insulated switchgear is often difficult because of this difference in cable termination locations. When the cables are cut and the live-front air insulated switchgear is removed and the dead-front air insulated switchgear is put in place, the cables and other parts may need to be re-trained, re-worked, re-terminated or completely replaced to accommodate the cable attachment on the replacement switchgear. The work and materials required to reconfigure the existing cables, which may be thick, rigid and heavy, and the connector terminations to meet different termination locations on the replacement switchgear is expensive and can involve extensive work, such as replacing the concrete pads, digging up old cables and/or trenching new cables, etc.

### SUMMARY

The following discussion discloses and describes dead-front air insulated switchgear that includes switches and fuses that are mounted to a top panel of the switchgear housing so as to lower the cable connection location of the switches and fuses. More specifically, when the switch and the fuse are mounted to the top panel, the switch bushing and fuse bushing well to which the cables are attached end up being located closer to a base of the switchgear.

Additional features of the disclosure will become apparent from the following description and appended claims, taken in conjunction with the accompanying drawings.

### BRIEF DESCRIPTION OF THE DRAWINGS

FIG. 1 is an isometric view of a dead-front air insulated switchgear positioned on a concrete pad; and

FIG. 2 is a cross-sectional type side view of the switchgear shown in FIG. 1 illustrating a switch and fuse mounted to a top panel of the switchgear housing.

### DETAILED DESCRIPTION OF THE EMBODIMENTS

The following discussion of the embodiments of the disclosure directed to dead-front air insulated switchgear that includes switches and fuses that are mounted to a top panel of the switchgear housing so as to lower the cable connection location of the switches and fuses is merely exemplary in nature, and is in no way intended to limit the invention or its applications or uses.

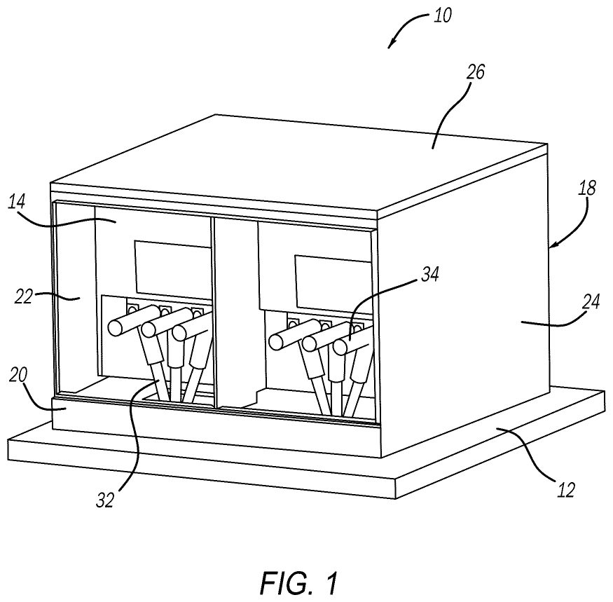

FIG. 1 is an isometric view of a dead-front air insulated switchgear 10 positioned on a concrete pad 12, where doors of the switchgear 10 have been removed to expose a grounded dead-front panel 14 at a front of the switchgear 10. For purposes of the discussion herein, the switchgear 10 is intended to represent any switchgear, pad mounted or otherwise, that includes any suitable configuration of components and devices that provide switching and disconnecting of and between one or more electrical cables coupled thereto that are part of a medium voltage electrical power distribution network. The switchgear 10 includes an outer housing 18 having a base 20 positioned on the pad 12, side panels 22 and 24 mounted to the base 20 and a top panel 26 mounted to the side panels 22 and 24. In this non-limiting design, the switchgear 10 includes two three-phase switches coupled to cables 32 by elbow connectors 34 at the front of the switchgear 10, where three of the cables 32 are at one side of the switchgear 10 and three of the cables 32 are at the other side of the switchgear 10, and at least six single-phase fuses (not shown in FIG. 1) coupled to cables (not shown) by elbow connectors (not shown) at the rear of the switchgear 10. The cables 32 may be the cables that were previously coupled to a live-front air insulated switchgear that is being replaced by the dead-front air insulated switchgear 10.

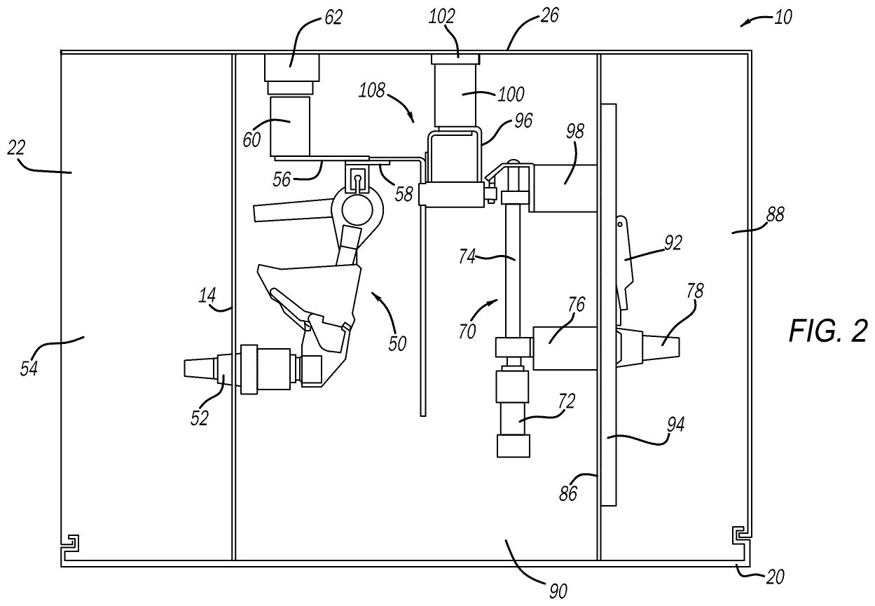

FIG. 2 is a cross-sectional type side view of the switchgear 10 showing a switch 50 of a known design, which is one of the two switches referred to above. The switch 50 includes a switch bushing 52 secured to the panel 14 at a lower location than in other known dead-front air insulated switchgear designs, where a front dead-front compartment 54 is provided between the front of the switchgear 10 and the dead-front panel 14, and where the connector 34 is connected to the bushing 52. The switch 50 also includes an energized top plate 56 having a tab 58, where the plate 56 is secured to the top panel 26 through an insulator 60 by a mount 62 in any suitable or known manner. Therefore, the existing cables 32 that may have been coupled to the live-front air insulated switchgear, and thus have a limited length, may be easily connected to the switch bushing 52 at this location.

The switchgear 10 also includes a fuse assembly 70 that is one of the six fuse assemblies referred to above. The fuse assembly 70 includes a fuse 74 having a collection portion 72 that collects exhaust when the fuse 74 operates. The fuse assembly 70 also includes a fuse bushing well 76 coupled to the fuse 74 and a bushing well insert 78 mounted to a grounded channel member 94. The grounded channel member 94 is mounted on a dead-front panel 86 via a pivot point at the rear of the switchgear 10, where the bushing well insert 78 is secured to grounded dead-front members at a lower location than in other known dead-front air insulated switchgear designs, and where an elbow connector is connected to the bushing well insert 78. Therefore, the existing cables that may have been coupled to the live-front air insulated switchgear, and thus have a limited length, may be easily connected to the fuse bushing well insert 78 at this location.

A rear dead-front compartment 88 is provided between the rear of the switchgear 10 and the dead-front panel 86, and the switch 50 and the fuse assembly 70 are provided in a medium voltage compartment 90 between the dead-front panels 14 and 86. The fuse assembly 70 is coupled to a handle 92 provided in the channel member 94 mounted to the panel 86 facing the compartment 88. The handle 92 is operated to allow the fuse 74 and the channel member 94 to be articulated through the dead-front panel 86 and be positioned within the compartment 88 to be replaced in a manner known to those skilled in the art, when necessary. The other end of the fuse 74 is coupled to an energized plate 96 and an insulated support 98 mounted to the channel member 94, where the plate 96 is secured to the top panel 26 through an insulator 100 by a mount 102 in any suitable or known manner. The switch 50 and the fuse assembly 70 are electrically coupled through an interconnector 108 via the tab 58 and the plate 96, respectively.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A switchgear comprising:
a housing including a base, side panels and a top panel opposite to the base, the base being configured to be positioned on a pad or other ground structure;
a first grounded dead-front panel positioned within the housing and extending from the base to the top panel, the first grounded dead-front panel separating a first cable compartment and a center voltage compartment; and
at least one switch positioned within the center voltage compartment and including a mounting end at one end of the at least one switch and a switch bushing at an opposite end of the at least one switch, the mounting end of the at least one switch being mounted to the top panel and the switch bushing being coupled to the first grounded dead-front panel and extending into the first cable compartment.

2. The switchgear according to claim 1 wherein the at least one switch is a plurality of switches each being positioned within the center voltage compartment and each including a mounting end at one end of the switch and a switch bushing at an opposite end of the switch, and wherein the mounting end of the switch is mounted to the top panel and the switch bushing is coupled to the first grounded dead-front panel and extending into the first cable compartment.

3. The switchgear according to claim 2 wherein the plurality of switches is two three-phase switches.

4. The switchgear according to claim 1 further comprising a second grounded dead-front panel positioned within the housing and extending from the base to the top panel, the second grounded dead-front panel separating a second cable compartment and the center voltage compartment, and at least one fuse assembly positioned within the center voltage compartment and including a mounting end at one end of the at least one fuse assembly and a fuse bushing well at an opposite end of the at least one fuse assembly, the mounting end of the at least one fuse assembly being mounted to the top panel and the fuse bushing well being coupled to the second grounded dead-front panel and extending into the second cable compartment.

5. The switchgear according to claim 4 wherein the at least one fuse assembly is a plurality of fuse assemblies each being positioned within the center voltage compartment and each including a mounting end at one end of the fuse assembly and a fuse bushing well at an opposite end of the fuse assembly, and wherein the mounting end of the fuse assembly is mounted to the top panel and the fuse bushing well is coupled to the second grounded dead-front panel and extending into the second cable compartment.

6. The switchgear according to claim 5 wherein the plurality of fuse assemblies is at least six fuse assemblies.

7. The switchgear according to claim 1 wherein the switchgear is a dead-front air insulated switchgear.

8. The switchgear according to claim 1 wherein the switchgear is part of a medium voltage power distribution network.

9. A switchgear comprising:
a housing including a base, side panels and a top panel opposite to the base, the base being configured to be positioned on a pad or other ground structure;
a grounded dead-front panel positioned within the housing and extending from the base to the top panel, the grounded dead-front panel separating a cable compartment and a center voltage compartment; and
at least one fuse assembly positioned within the center voltage compartment and including a mounting end at one end of the at least one fuse assembly and a fuse bushing well at an opposite end of the at least one fuse assembly, the mounting end of the at least one fuse assembly being mounted to the top panel and the fuse bushing well being coupled to the grounded dead-front panel and extending into the cable compartment.

10. The switchgear according to claim 9 wherein the at least one fuse assembly is a plurality of fuse assemblies each being positioned within the center voltage compartment and each including a mounting end at one end of the fuse assembly and a fuse bushing well at an opposite end of the fuse assembly, and wherein the mounting end of the fuse assembly is mounted to the top panel and the fuse bushing well is coupled to the grounded dead-front panel and extending into the cable compartment.

11. The switchgear according to claim 10 wherein the plurality of fuse assemblies is at least six fuse assemblies.

12. The switchgear according to claim 9 wherein the switchgear is a dead-front air insulated switchgear.

13. The switchgear according to claim 9 wherein the switchgear is part of a medium voltage power distribution network.

14. A switchgear configured to be part of a medium voltage power distribution network, the switchgear comprising:
a housing including a base, side panels and a top panel opposite to the base, the base being configured to be positioned on a pad or other ground structure;
a first grounded dead-front panel positioned within the housing and extending from the base to the top panel and a second grounded dead-front panel positioned within the housing and extending from the base to the top panel, the first and second grounded dead-front panels defining a center medium voltage compartment therebetween, wherein a first cable compartment is defined by the first grounded dead-front panel opposite to the center medium voltage compartment and a second cable compartment is defined by the second grounded dead-front panel opposite to the center medium voltage compartment;
a plurality of switches positioned within the center medium voltage compartment and each including a mounting end at one end of the switch and a switch bushing at an opposite end of the switch, the mounting end of the switch being mounted to the top panel and the switch bushing being coupled to the first grounded dead-front panel and extending into the first cable compartment; and
a plurality of fuse assemblies positioned within the center medium voltage compartment and each including a mounting end at one end of the fuse assembly and a fuse bushing well at an opposite end of the fuse assembly, the mounting end of the fuse assembly being mounted to the top panel and the fuse bushing well being coupled to the second grounded dead-front panel and extending into the second cable compartment.

15. The switchgear according to claim 14 wherein the plurality of switches is two three-phase switches and the plurality of fuse assemblies is at least six fuse assemblies.
